(19) United States
(12) Patent Application Publication
(10) Pub. No.: US 2011/0156615 A1
(43) Pub. Date: Jun. 30, 2011

(54) BACKLIGHT DRIVING CIRCUIT FOR USE IN LCD PANEL

(75) Inventors: Shih-Hsien Chang, Taoyuan Hsien (TW); Yao-Tien Huang, Taoyuan Hsien (TW)

(73) Assignee: DELTA ELECTRONICS, INC., Taoyuan Hsien (TW)

(21) Appl. No.: 12/974,846

(22) Filed: Dec. 21, 2010

(30) Foreign Application Priority Data
Dec. 30, 2009 (TW) 098145865

(51) Int. Cl. H05B 37/02

(52) U.S. Cl. 315/297

(57) ABSTRACT

A backlight driving circuit includes a voltage-regulating circuit, a self-excited oscillation circuit, a transformer, a rectifying circuit and a filtering circuit. The voltage-regulating circuit is used for receiving an input voltage and adjusting the input voltage into a DC voltage. The self-excited oscillation circuit generates an oscillation voltage according to the DC voltage. The transformer includes a first primary winding assembly and a secondary winding assembly. The first primary winding assembly is connected with the self-excited oscillation circuit for receiving the oscillation voltage, so that the secondary winding assembly is induced to generate an AC output voltage. The rectifying circuit is used for rectifying the AC output voltage into a DC driving voltage. The filtering circuit is connected to the rectifying circuit and plural LED strings for filtering the DC driving voltage, so that the plural LED strings are driven by the filtered DC driving voltage.

### FIELD OF THE INVENTION

The present invention relates to a backlight driving circuit, and more particularly to a backlight driving circuit for use in a LCD panel.

### BACKGROUND OF THE INVENTION

Nowadays, LCD televisions have experienced great growth and are now rapidly gaining in popularity. As known, backlight modules are crucial components of LCD panels. In general, cold cathode fluorescent lamps (CCFLs) and light emitting diodes (LEDs) have been widely used as light sources of the backlight modules. Since a cold cathode fluorescent lamp uses a mercury gas, it is prone to environmental pollution. With maturity of the LED technology, LED gradually replaces CCFL as the backlight source of the LCD television. In comparison with CCFL, LED has reduced volume and power consumption. That is, the use of LED is effective for facilitating miniaturization of the LCD panel, achieving better color saturation and meeting the environmentally-friendly requirement.

Generally, the LCD panel of a LCD television comprises plural LED strings. Each LED string comprises a plurality of LEDs connected in series. For driving each LED string, a driving chip is used for controlling on/off statues of the switch element of a power converting circuit in order to convert an input voltage into a regulated voltage for driving the LED string. As the size of the LCD television is gradually increased, the number of LED strings included in the LCD panel is increased. In addition, for achieving desired brightness, the number of LEDs of each LED string should be increased. That is, the number of driving chips is correspondingly increased. The increase of driving chips is detrimental to miniaturization of the backlight module of the LCD television. Moreover, due to a great number of driving chips, the wiring cost is increased.

Therefore, there is a need of providing a backlight driving circuit for use in a LCD panel so as to obviate the drawbacks encountered from the prior art.

### SUMMARY OF THE INVENTION

It is an object of the present invention to provide a backlight driving circuit for use in a LCD panel in order to reduce fabricating cost and volume.

In accordance with an aspect of the present invention, there is provided a backlight driving circuit for use in a LCD panel to drive plural LED strings. The backlight driving circuit includes a self-excited oscillation circuit, a transformer, a rectifying circuit and a filtering circuit. The self-excited oscillation circuit is used for receiving a DC voltage and generating an oscillation voltage according to the DC voltage. The transformer includes a first primary winding assembly and a secondary winding assembly. The first primary winding assembly is connected with the self-excited oscillation circuit for receiving the oscillation voltage, so that the secondary winding assembly is induced to generate an AC output voltage. The rectifying circuit is connected to the secondary winding assembly of the transformer for rectifying the AC output voltage into a DC driving voltage. The filtering circuit is connected to the rectifying circuit and the plural LED strings for filtering the DC driving voltage, so that the plural LED strings are driven by the filtered DC driving voltage.

In accordance with another aspect of the present invention, there is provided a backlight driving circuit for use in a LCD panel to drive plural LED strings. The backlight driving circuit includes a voltage-regulating circuit, a self-excited oscillation circuit, a transformer, a rectifying circuit and a filtering circuit. The voltage-regulating circuit is used for receiving an input voltage and adjusting the input voltage into a DC voltage. The self-excited oscillation circuit is connected to the voltage-regulating circuit for receiving the DC voltage and generating an oscillation voltage according to the DC voltage. The transformer includes a first primary winding assembly and a secondary winding assembly. The first primary winding assembly is connected with the self-excited oscillation circuit for receiving the oscillation voltage, so that the secondary winding assembly is induced to generate an AC output voltage. The rectifying circuit is connected to the secondary winding assembly of the transformer for rectifying the AC output voltage into a DC driving voltage. The filtering circuit is connected to the rectifying circuit and the plural LED strings for filtering the DC driving voltage, so that the plural LED strings are driven by the filtered DC driving voltage.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is schematic circuit diagram illustrating a backlight driving circuit for use in a LCD panel according to a first embodiment of the present invention;

FIG. 2 is schematic circuit diagram illustrating a backlight driving circuit for use in a LCD panel according to a second embodiment of the present invention;

FIG. 3 is schematic circuit diagram illustrating an exemplary voltage-adjusting circuit of the backlight driving circuit as shown in FIG. 2; and

FIG. 4 is a schematic timing waveform diagram illustrating related voltage signals described in the backlight driving circuit as shown in FIGS. 2 and 3.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

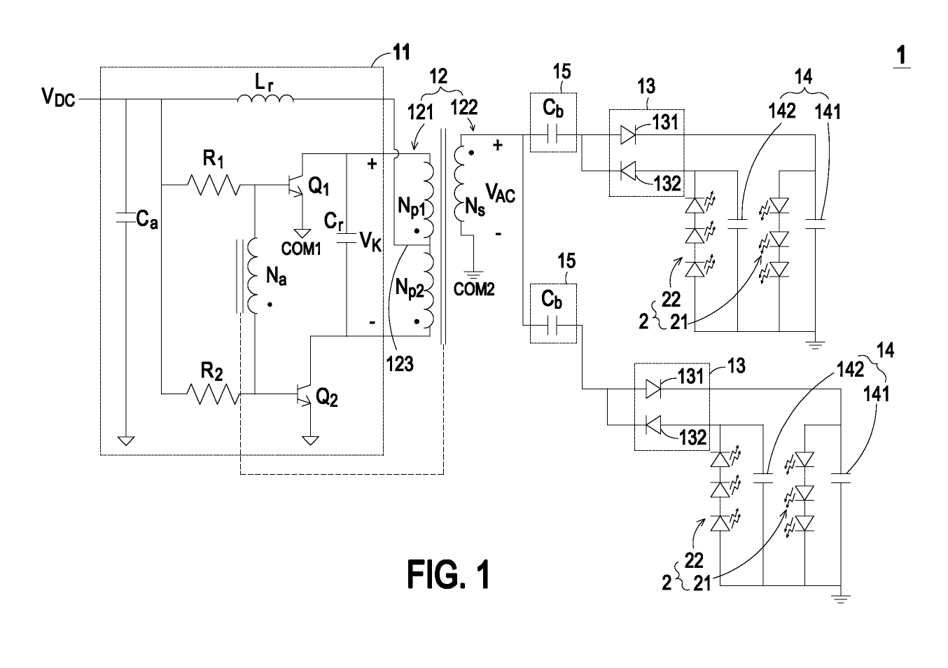

FIG. 1 is schematic circuit diagram illustrating a backlight driving circuit for use in a LCD panel according to a first embodiment of the present invention. The backlight driving circuit 1 is applied to a LCD panel for driving plural LED strings 2. As shown in FIG. 1, the backlight driving circuit 1 comprises a self-excited oscillation circuit 11, a transformer 12, a rectifying circuit 13, a filtering circuit 14 and a current-sharing circuit 15. An example of the self-excited oscillation circuit 11 includes but is not limited to a Royer converter. The self-excited oscillation circuit 11 receives a DC voltage V_{DC}. According to the DC voltage V_{DC}, the self-excited oscillation circuit 11 generates an oscillation voltage Vₖ to a primary side 121 of the transformer 12.

Please refer to FIG. 1 again. The self-excited oscillation circuit 11 comprises an inductor Lᵣ, a first capacitor Cₐ, a second capacitor Cᵣ, a first resistor R₁, a second resistor R₂, a first switch element Q₁ and a second switch element Q₂. The equivalent inductance of the inductor Lᵣ, the second capacitor Cᵣ and the transformer 12 will result in the resonant action, so that the oscillation voltage Vₖ is at the primary side 121 of the transformer 12. An example of the first switch element Q₁ includes but is not limited an NPN bipolar junction transistor. An example of the second switch element Q₂ includes but is not limited an NPN bipolar junction transistor.

The transformer 12 comprises a first primary winding assembly Nₚ₁, a second primary winding assembly Nₚ₂, a secondary winding assembly Nₛ and an auxiliary winding assembly Nₐ. The first primary winding assembly Nₚ₁ and the second primary winding assembly Nₚ₂ are arranged at the primary side 121 of the transformer 12. A center-tapped head 123 is arranged between the first primary winding assembly Nₚ₁ and the second primary winding assembly Nₚ₂, and connected to the inductor Lᵣ. A first end of the first primary winding assembly Nₚ₁ is connected to the second capacitor Cᵣ and the first switch element Q₁. A second end of the first primary winding assembly Nₚ₁ is connected to the center-tapped head 123. A first end of the second primary winding assembly Nₚ₂ is connected to the second capacitor Cᵣ and the second switch element Q₂. A second end of the second primary winding assembly Nₚ₂ is connected to the center-tapped head 123. The secondary winding assembly Nₛ is arranged at a secondary side 122 of the transformer 12. A first end of the secondary winding assembly Nₛ is connected to a common terminal COM2. A first end of the auxiliary winding assembly Nₐ is connected to the resistor R₁ and the first switch element Q₁. A second end of the auxiliary winding assembly Nₐ is connected to the second resistor R₂ and the second switch element Q₂.

In this embodiment, the first switch element Q₁ and the second switch element Q₂ are NPN bipolar junction transistors. The collector (C) of the first switch element Q₁ is connected to the second capacitor Cᵣ and the first primary winding assembly Nₚ₁. The base (B) of the first switch element Q₁ is connected to the auxiliary winding assembly Nₐ and the first resistor R₁. The emitter (E) of the first switch element Q₁ is connected to a common terminal COM1. The collector of the second switch element Q₂ is connected to the second capacitor Cᵣ and the second primary winding assembly Nₚ₂. The base of the second switch element Q₂ is connected to the auxiliary winding assembly Nₐ and the second resistor R₂. The emitter of the second switch element Q₂ is connected to the common terminal COM1.

Due to a voltage change at the primary side 121 of the transformer 12, the auxiliary winding assembly Nₐ is induced to generate a control voltage. According to the control voltage, the first switch element Q₁ and the second switch element Q₂ are alternately conducted, and thus the oscillation voltage Vₖ is alternately transmitted to the first primary winding assembly Nₚ₁ and the second primary winding assembly Nₚ₂. Accordingly, the secondary winding assembly Nₛ at the secondary side 122 of the transformer 12 is induced to generate an AC output voltage V_{AC}. In a case that the control voltage is at a high-level state, the first switch element Q₁ is conducted but the second switch element Q₂ is shut off, so that the oscillation voltage Vₖ is transmitted to the first primary winding assembly Nₚ₁ of the transformer 12. Whereas, in a case that the control voltage is at a low-level state, the first switch element Q₁ is shut off but the second switch element Q₂ is conducted, so that the oscillation voltage Vₖ is transmitted to the second primary winding assembly Nₚ₂ of the transformer 12.

Please refer to FIG. 1 again. By the rectifying circuit 13, the AC output voltage V_{AC} that is outputted form the secondary winding assembly Nₛ of the transformer 12 is rectified into a DC driving voltage. In this embodiment, the rectifying circuit 13 comprises a first rectifier 131 and a second rectifier 132. Each of the first rectifier 131 and the second rectifier 132 includes but is not limited to a diode. The filtering circuit 14 comprises a first filter 141 and a second filter 142 for filtering the DC driving voltage. The filtered DC driving voltage is used for driving operations of the plural LED strings 2. For clarification and brevity, the plural LED strings 2 comprise a first LED string 21 and a second LED string 22. Each of the first filter 141 and the second filter 142 includes but is not limited to a capacitor. The first rectifier 131 is connected to the secondary winding assembly Nₛ of the transformer 12, the first LED string 21 and the first filter 141. The second rectifier 132 is connected to the secondary winding assembly Nₛ of the transformer 12, the second LED string 22 and the second filter 142.

The anode of the first rectifier 131 is connected to the cathode of the second rectifier 132. The cathode of the LED at the second end of the first LED string 21 is connected to the anode of the LED at the second end of the second LED string 22. The cathode of the first rectifier 131 is connected to the anode of LED at the first end of the first LED string 21. The anode of the second rectifier 132 is connected to the cathode of the LED at the first end of the second LED string 22. As such, the positive voltage of the AC output voltage V_{AC} is transmitted to the first LED string 21 through the first rectifier 131, and the negative voltage of the AC output voltage V_{AC} is transmitted to the second LED string 22 through the second rectifier 132. Under this circumstance, the first LED string 21 and the second LED string 22 are alternately enabled.

The current-sharing circuit 15 is interconnected between the secondary winding assembly Nₛ of the transformer 12 and the rectifying circuit 13. In this embodiment, the current-sharing circuit 15 comprises a capacitor C_{b}. The current-sharing circuit 15 is used for stabilizing the currents passing through the rectifying circuit 13, thereby balancing the currents passing through the first LED string 21 and the second LED string 22.

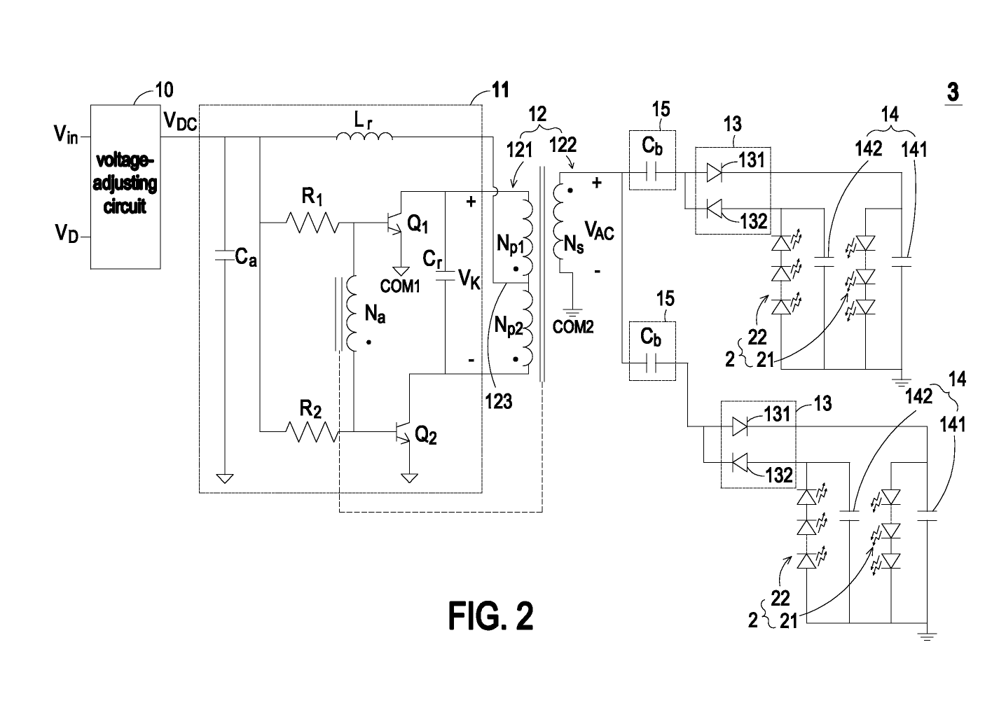

FIG. 2 is schematic circuit diagram illustrating a backlight driving circuit for use in a LCD panel according to a second embodiment of the present invention. As shown in FIG. 2, the backlight driving circuit 3 comprises a self-excited oscillation circuit 11, a transformer 12, a rectifying circuit 13, a filtering circuit 14, a current-sharing circuit 15 and a voltage-adjusting circuit 10. The configurations and operating principles of the self-excited oscillation circuit 11, the transformer 12, the rectifying circuit 13, the filtering circuit 14 and the current-sharing circuit 15 are similar to those illustrated in FIG. 1, and are not redundantly described herein. The voltage-adjusting circuit 10 receives an input voltage Vᵢₙ and a dimming signal V_{D}. The dimming signal V_{D} is transmitted from a system circuit board. According to a dimming signal V_{D}, the magnitude or on phase of the DC voltage V_{DC} is adjusted by the voltage-adjusting circuit 10. In addition, according to a dimming signal V_{D}, the input voltage Vᵢₙ is converted into the DC voltage V_{DC} by the voltage-adjusting circuit 10.

In some embodiments, the input voltage Vᵢₙ is from a DC power source, and the voltage-adjusting circuit 10 is a buck DC-to-DC converter.

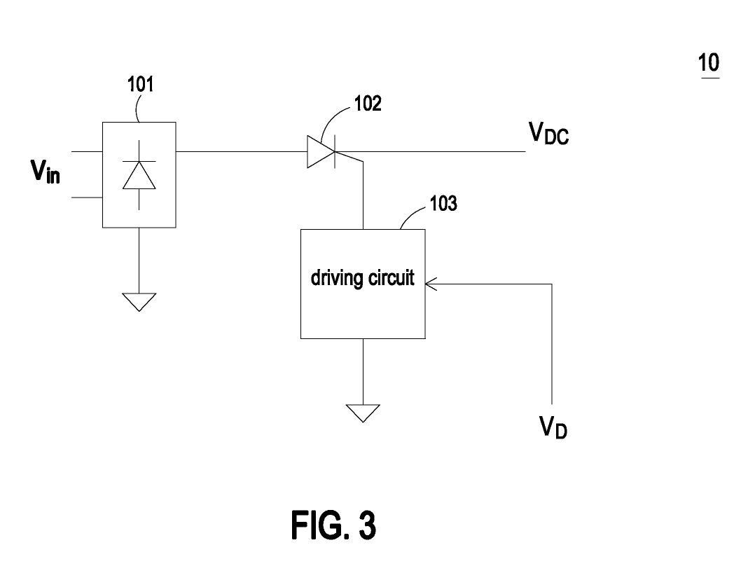

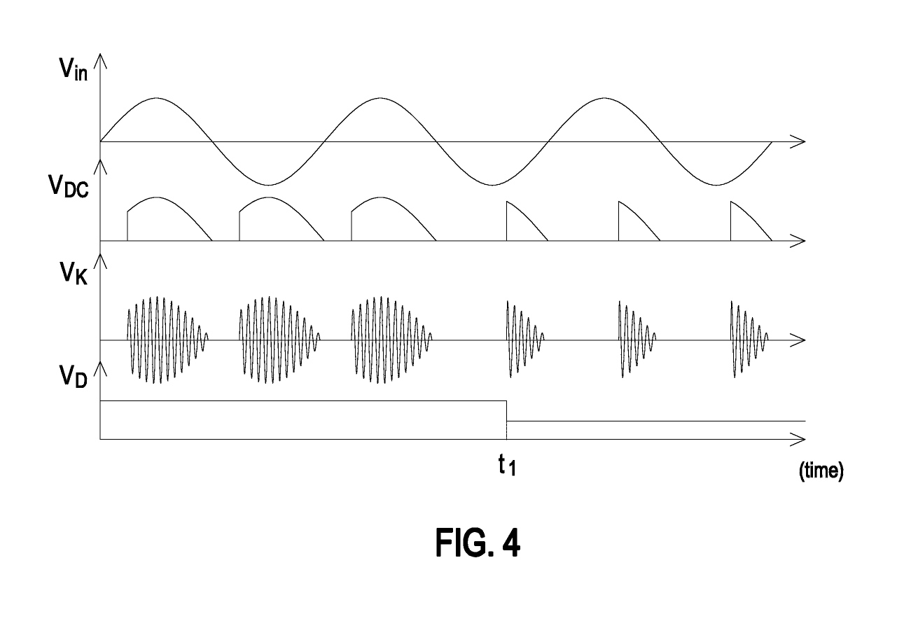

FIG. 3 is schematic circuit diagram illustrating an exemplary voltage-adjusting circuit of the backlight driving circuit as shown in FIG. 2. FIG. 4 is a schematic timing waveform diagram illustrating related voltage signals described in the backlight driving circuit as shown in FIGS. 2 and 3. As shown in FIG. 3, the voltage-adjusting circuit 10 comprises a rectifying circuit 101, a silicon-controlled rectifier (SCR) 102 and a driving circuit 103. The silicon-controlled rectifier 102 is interconnected between the rectifying circuit 101 and the driving circuit 103. In a case that the input voltage Vᵢₙ is from an AC power source, the input voltage Vᵢₙ is firstly rectified into a transition DC voltage. The dimming signal V_{D} is received by the driving circuit 103. According to the dimming signal V_{D}, the silicon-controlled rectifier 102 is conducted under control of the driving circuit 103. In this situation, the on phase of the DC voltage V_{DC} to be transmitted to the self-excited oscillation circuit 11 is adjustable in order to adjust the oscillating time of the oscillation voltage Vₖ in each half cycle. Alternatively, the silicon-controlled rectifier 102 can be replaced with a thyristor, but it is not limited thereto.

Please refer to FIG. 4. When the dimming signal V_{D} is at a high-level state (e.g. 6V) from t=0 to t=t₁, the silicon-controlled rectifier 102 outputs the DC voltage V_{DC} having a longer on duration after a lower phase (e.g. 30 degree). Whereas, when the dimming signal V_{D} is at a low-level state (e.g. 1V) after t=t₁, the silicon-controlled rectifier 102 outputs the DC voltage V_{DC} having a shorter on duration after a higher phase (e.g. 120 degree). By controlling the on duration of the DC voltage V_{DC} according to the dimming signal V_{D}, the oscillating time of the oscillation voltage Vₖ in each half cycle is adjustable. The DC voltage V_{DC} having a longer on duration may result in a higher brightness value of the LED strings 2. Whereas, the DC voltage V_{DC} having a shorter on duration may result in a lower brightness value of the LED strings 2.

From the above description, the backlight driving circuit of the present invention has many advantages over the prior art technology. According to the present invention, the oscillation voltage is generated by the self-excited oscillation circuit, so that the AC output voltage is induced at the primary side of the transformer. The AC output voltage is rectified and filtered by the rectifying circuit and the filtering circuit, thereby driving the plural LED strings. Since no additional driving circuit is required according to the self-excited driving technology, the backlight driving circuit of the present invention is more cost-effective and has smaller volume in comparison with the prior art technology. Moreover, since the oscillating time of the oscillation voltage in each half cycle is adjustable by means of the voltage-adjusting circuit and the dimming signal, the brightness value of the plural LED strings can be adjusted as required.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight driving circuit for use in a LCD panel to drive plural LED strings, said backlight driving circuit comprising:
a self-excited oscillation circuit for receiving a DC voltage and generating an oscillation voltage according to said DC voltage;
a transformer comprising a first primary winding assembly and a secondary winding assembly, wherein said first primary winding assembly is connected with said self-excited oscillation circuit for receiving said oscillation voltage, so that said secondary winding assembly is induced to generate an AC output voltage;
a rectifying circuit connected to said secondary winding assembly of said transformer for rectifying said AC output voltage into a DC driving voltage; and
a filtering circuit connected to said rectifying circuit and said plural LED strings for filtering said DC driving voltage, so that said plural LED strings are driven by said filtered DC driving voltage.

2. The backlight driving circuit according to claim 1 wherein said transformer further comprises a second primary winding assembly and a center-tapped head, wherein said center-tapped head is arranged between said first primary winding assembly and said second primary winding assembly.

3. The backlight driving circuit according to claim 2 wherein said self-excited oscillation circuit comprises:
an inductor connected to said center-tapped head of said transformer for receiving said DC voltage; and
a capacitor having both ends respectively connected to said first primary winding assembly and said second primary winding assembly of said transformer, wherein an equivalent inductance of said inductor, said capacitor and said transformer result in a resonant action, so that said oscillation voltage is generated at a primary side of said transformer.

4. The backlight driving circuit according to claim 3 wherein said transformer further comprises an auxiliary winding assembly, and said auxiliary winding assembly is induced to generate a control voltage according to a voltage change at said primary side of said transformer.

5. The backlight driving circuit according to claim 4 wherein said self-excited oscillation circuit further comprises:
a first switch element connected to a first end of said auxiliary winding assembly, said capacitor and said first primary winding assembly; and
a second switch element connected to a second end of said auxiliary winding assembly, said capacitor and said second primary winding assembly,
wherein said first switch element and said second switch element are alternately conducted in response to said control voltage, so that said secondary winding assembly of said transformer is induced to generate an AC output voltage.

6. The backlight driving circuit according to claim 1 wherein said rectifying circuit comprises:
a first rectifier connected to said secondary winding assembly of said transformer and a first LED string of said plural LED strings; and
a second rectifier connected to said secondary winding assembly of said transformer and a second LED string of said plural LED strings.

7. The backlight driving circuit according to claim 6 wherein a positive voltage of said AC output voltage is transmitted to said first LED string through said first rectifier, and a negative voltage of said AC output voltage is transmitted to said second LED string through said second rectifier.

8. The backlight driving circuit according to claim 7 wherein an anode of said first rectifier is connected to a cathode of said second rectifier, a cathode of said first rectifier is connected to an anode of the LED at a first end of said first LED string, an anode of said second rectifier is connected to a cathode of the LED at a first end of said second LED string, and a cathode of the LED at a second end of said first LED string is connected to an anode of the LED at a second end of said second LED string.

9. The backlight driving circuit according to claim 6 wherein said filtering circuit comprises:
a first filter connected to said first rectifier and said first LED string; and
a second filter connected to said second rectifier and said second LED string.

10. The backlight driving circuit according to claim 1 further comprising a current-sharing circuit, which is connected to said secondary winding assembly of said transformer and said rectifying circuit for stabilizing currents passing through said rectifying circuit, thereby balancing said currents passing through said plural LED strings.

11. The backlight driving circuit according to claim 1 further comprising a voltage-adjusting circuit connected to said self-excited oscillation circuit and receiving an input voltage, wherein said input voltage is converted into said DC voltage by said voltage-adjusting circuit according to a dimming signal.

12. The backlight driving circuit according to claim 11 wherein said voltage-adjusting circuit includes a silicon-controlled rectifier.

13. The backlight driving circuit according to claim 11 wherein said voltage-adjusting circuit includes a thyristor.

14. A backlight driving circuit for use in a LCD panel to drive plural LED strings, said backlight driving circuit comprising:
a voltage-regulating circuit for receiving an input voltage and adjusting said input voltage into a DC voltage;
a self-excited oscillation circuit connected to said voltage-regulating circuit for receiving said DC voltage and generating an oscillation voltage according to said DC voltage;
a transformer comprising a first primary winding assembly and a secondary winding assembly, wherein said first primary winding assembly is connected with said self-excited oscillation circuit for receiving said oscillation voltage, so that said secondary winding assembly is induced to generate an AC output voltage;
a rectifying circuit connected to said secondary winding assembly of said transformer for rectifying said AC output voltage into a DC driving voltage; and
a filtering circuit connected to said rectifying circuit and said plural LED strings for filtering said DC driving voltage, so that said plural LED strings are driven by said filtered DC driving voltage.
